(19) United States
(12) Patent Application Publication
(10) Pub. No.: US 2016/0012458 A1
(43) Pub. Date: Jan. 14, 2016

(54) METHODS AND SYSTEMS FOR ONLINE QUESTIONNAIRES

(71) Applicant: Max Israel, Seattle, WA (US)

(72) Inventor: Max Israel, Seattle, WA (US)

(21) Appl. No.: 14/327,031

(22) Filed: Jul. 9, 2014

(51) Int. Cl. G06Q 30/02

(52) U.S. Cl. CPC G06Q 30/0203

(57) ABSTRACT

An online questionnaire elicits a respondent to simulate empathetic responses through a story type format. By way of example, a person sharing a happy story or a good experience may smile and nod in a face-to-face dialogue; whereas a person sharing a sad story or a bad experience may offer a different set of expressions such as a downturned mouth, a furrowed brow or a slow nod. The online questionnaire includes a plurality of prompts and subsequent options selectable by the respondent. The online questionnaire interprets a previously selected option to generate a subsequent prompt. Results of an online questionnaire or questionnaires may be aggregated into a report that provides a score or a grade to a particular audience, such as employees of an organization.

### FIELD OF THE INVENTION

The present invention generally relates to systems and methods for providing and processing questionnaires, and more specifically to generating online questionnaires that provide prompts accompanied by a visual depiction that tells a story to a respondent and scoring and reporting a result obtained from the questionnaire in which the report also provides a visual depiction that tells a story about the result.

### BACKGROUND

Numerous organizations such as, but not limited service-oriented organizations, often seek to obtain substantive and value-added feedback from customers, stakeholders, employees, vendors, or others (generally hereinafter referred to as “customers” or “respondents”). By way of example, many such organizations have seen a rapid rise in organizational value and efficiency when receiving effective feedback from their customers via online or web-based questionnaires. For purpose of the description herein, the organizations or those soliciting responses may also be referred to as an interlocutor.

The proliferation of organizations asking for feedback coupled with the traditionally mundane ways in which these questionnaires are executed has reduced the customer's willingness to share information or provide quality feedback. People in the industry refer to this as “survey fatigue”, and it deprives organizations of feedback that may be beneficial to operating efficiently, identifying and/or correcting flaws, and improving quality among other things.

Traditional online surveys fail to offer empathetic cues and often leave the respondents feeling as if their feedback will not be appreciated, will not be adequately understood, or will be bureaucratically filtered. As a result of these common issues, as well as others, the respondents may become disinclined to invest sufficient time and energy in their responses.

### SUMMARY

In one embodiment, the present invention generally relates to systems and methods that utilize computer-readable instructions for an online questionnaire that elicits a respondent to simulate empathetic responses through a story type format. By way of example, a person sharing a happy story or a good experience may smile and nod in a face-to-face dialogue; whereas a person sharing a sad story or a bad experience may offer a different set of expressions such as a down-turned mouth, a furrowed brow or a slow nod. The online questionnaire includes a plurality of prompts and subsequent options selectable by the respondent. The online questionnaire interprets a previously selected option to generate a subsequent prompt. Results of an online questionnaire or questionnaires may be aggregated into a report that provides a score or a grade to a particular audience, such as employees of an organization.

In one aspect of the present invention, a computer-implemented method for providing an online questionnaire to a respondent includes the steps of (1) providing a situational statement to the respondent, the situational statement coupled with an image of an environment that relates to an experience of the respondent to which the questionnaire is directed; (2) providing a prompt to the respondent; (3) providing a plurality of options to the prompt; (4) determining a progression of subsequent prompts based on the selected option by the respondent; and (5) providing the subsequent prompts through a textual and a visual interface that encourages a continued interaction by the respondent.

In another aspect of the present invention, a method for scoring and reporting results from an online questionnaire includes the steps of (1) ascribing value to selected options provided by a respondent to prompts in the online questionnaire; (2) populating a database that includes the ascribed values; (3) using the ascribed values, aggregating an overall score for the online questionnaire based on an experience of the respondent; and (4) providing the overall score in combination with a visual depiction in a report that represents the experience of the respondent.

### BRIEF DESCRIPTION OF THE DRAWINGS

In the drawings, identical reference numbers identify similar elements or acts. The sizes and relative positions of elements in the drawings may not be necessarily drawn to scale. For example, the shapes of various elements and angles may not be drawn to scale, and some of these elements may be arbitrarily enlarged or positioned to improve drawing legibility.

FIG. 1 is a system diagram of a suitable computing environment, such as a personal computer or personal mobile computing device, for practicing the systems and methods of various embodiments of the subject matter disclosed herein;

FIG. 2 is a system diagram of a suitable networked computing environment wherein a user may employ the various systems and methods of the subject matter disclosed herein;

FIG. 3 is a flow diagram of a method for providing an online questionnaire according to an embodiment of the present invention;

FIG. 4 is a perspective view of a visual environment with an initial prompt viewable by a respondent in an online questionnaire according to an embodiment of the present invention;

FIG. 5 is a perspective view of a visual and contextual environment with available responses to a prompt provided by an online questionnaire according to an embodiment of the present invention;

FIGS. 6A and 6B are perspective views showing a visual and contextual environment aligned with a response selected by a respondent in an online questionnaire according to an embodiment of the present invention; and

FIG. 7 is a flow diagram of a method for scoring and reporting results from one or more online questionnaires according to an embodiment of the present invention.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with systems and methods for preparing, processing, analyzing and sharing questionnaires and/or surveys may have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, which is as “including, but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention

Embodiments of the invention may be operational with numerous general purpose or special purpose computing system environments or configurations. Examples of well-known computing systems, environments, and/or configurations that may be suitable for use with the invention include, but are not limited to, personal computers (PCs), servers, networked computing systems, hand-held or laptop devices, multiprocessor systems, microprocessor-based systems, set top boxes, programmable consumer electronics, network PCs, minicomputers, mainframe computers, handsets, dynamic billboards, distributed computing environments that include any of the above systems or devices, and the like.

In one embodiment, the present invention generally relates to systems and methods that utilize computer-readable instructions for integrating a questionnaire or a survey with a feedback platform. In another embodiment, the present invention generally relates to systems and methods that offer empathetic verbal and/or non-verbal cues to a questionnaire or survey that relates a story in a conversational and interlocutory manner.

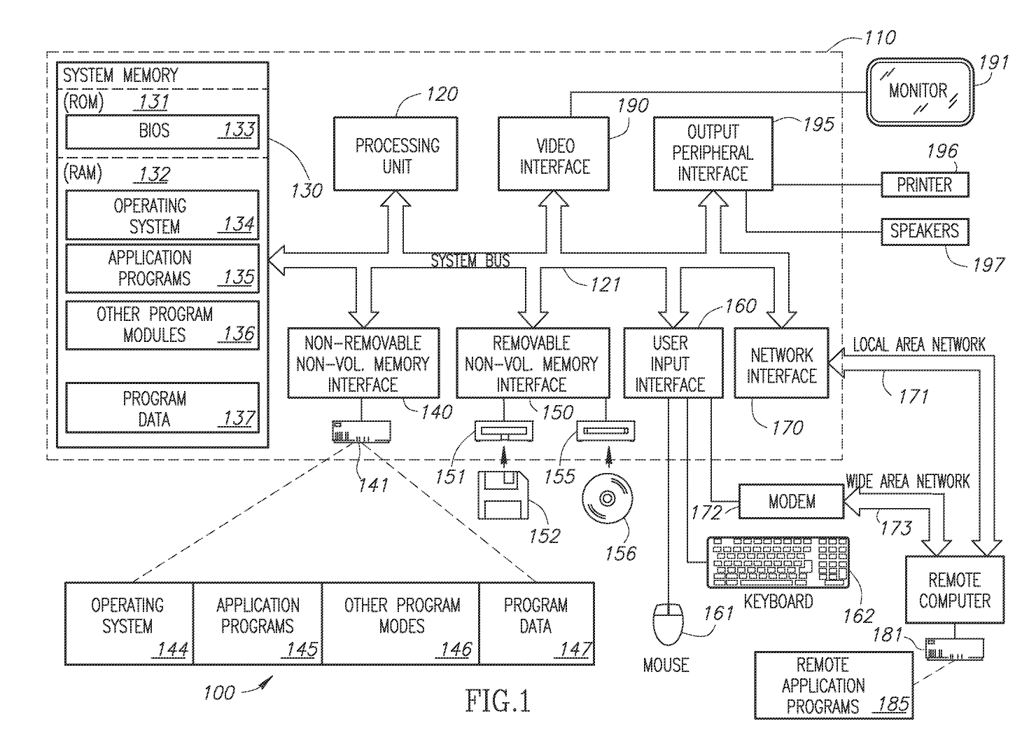

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media may include volatile and nonvolatile media, and/or removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

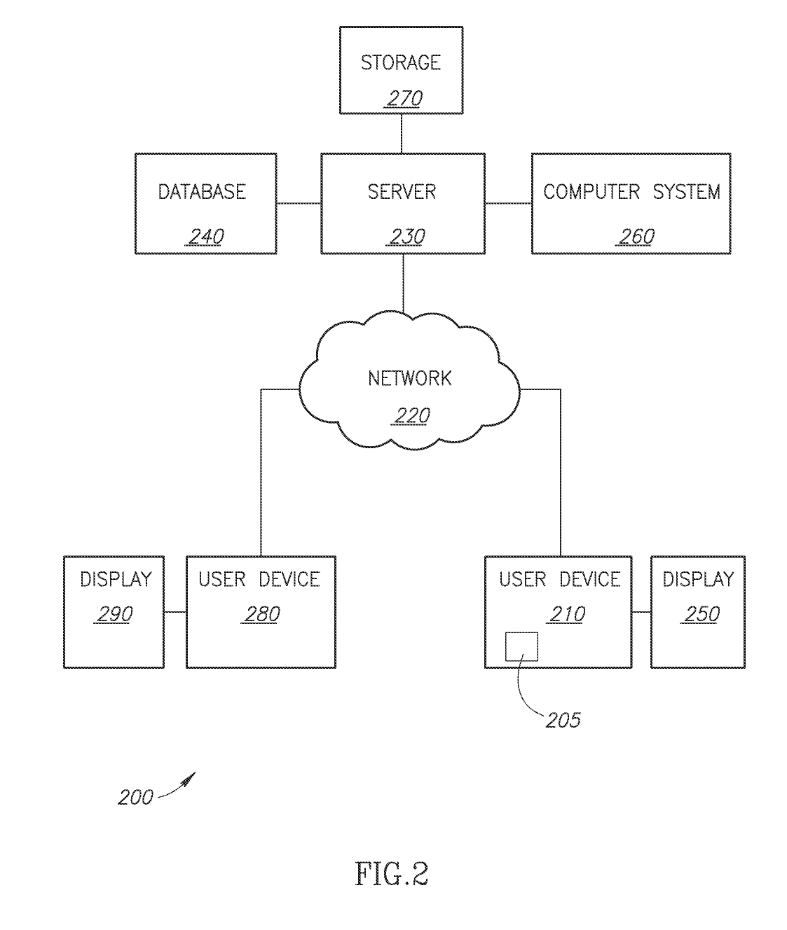

Referring now to FIG. 2, an embodiment of the present invention can be described in the context of an exemplary computer network system 200 as illustrated. System 200 includes electronic user devices 210, 280, such as cellular or mobile telephones, tablets, personal computers or workstations, that are linked via a communication medium, such as a network 220 (e.g., the Internet), to an electronic device or system, such as a server 230. The server 230 may further be coupled, or otherwise have access, to a database 240, electronic storage 270 and a computer system 260. Although the embodiment illustrated in FIG. 2 includes one server 230 coupled to two user devices 210, 280 via the network 220, it should be recognized that embodiments of the invention may be implemented using two or more such user devices coupled to one or more such servers. Moreover, the network 220 may include or otherwise be coupled to one or more telecommunication towers (not shown) that provide network connectivity to one or more cellular or mobile telephones.

In an embodiment, each of the user devices 210, 280 and server 230 may include all or fewer than all of the features associated with the computer 110 illustrated in and discussed with reference to FIG. 1. User devices 210, 280 include or are otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, a browser or other applications, running on the user devices 210, 280 can cooperate in two-way communication with server 230. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

Throughout the specification and claims which follow, the word “questionnaire” is meant as a broad term that may include a form or other document, digital or otherwise, containing a set of questions or prompts addressed to a statistically significant number of subjects as a way of gathering information. The word “questionnaire” may also take the form of a survey and be used synonymously therewith. Likewise, the word “online” is meant as a broad term that may include networked and non-networked devices such as, but not limited to, computers, tablets, digital pads, mobile communication devices, etc.

To minimize or avoid “survey fatigue,” which was discussed in the Background section above, an embodiment of the present invention offers empathetic, frequent, non-verbal feedback that a real conversational interlocutor would. Stated otherwise, a face-to-face conversation typically involves a first person relating a story to a second person (or vice-versa), wherein the dialogue generally includes both verbal and non-verbal cues that indicate a level of engagement or attention with the dialogue, an exchange of values in the experience, and a level of understanding about the information being exchanged or otherwise shared.

In one embodiment, a questionnaire system elicits the respondent to simulate empathetic responses through a story type format. By way of example, a person sharing a happy story or a good experience may smile and nod in a face-to-face dialogue; whereas a person sharing a sad story or a bad experience may offer a different set of expressions such as a downturned mouth, a furrowed brow or a slow nod. The ability to share such non-verbal cues indicates to the respondent that the end-listener is genuinely engaged. Preferably, the respondent would be inclined to invest sufficient time and energy into the story, and perhaps add more valuable detail.

In contrast, a questionnaire that fails to adequately empathize (or to appear to empathize) with the respondent leaves the respondent feeling less satisfied for having shared the story. Generally, the respondent who believes that the interlocutor has listened or will be invested in listening will generally feel more satisfied than the respondent who believes that the interlocutor has not really listened, has only superficially listened or is perceived to not be fully invested in listening.

One result of online questionnaires that fail to offer an empathetic response may be to create an aversion to sharing feedback, or to degrade the relationship between a customer and, for example, a company or brand in the same way that failing to be a genuine listener might degrade the friendship that a poor listener has with another person. Studies have shown that a failure to empathize may be caustic to relationships, whether those relationships are interpersonal, organizational or take some other form.

By way of example, a traditional questionnaire takes a respondent through a series of questions about a customer experience. In one type of questionnaire format, the respondent may be asked to provide responses using a Likert scale, which may include a series of bubbles representing a continuum of agreeability (e.g., strongly agree to highly disagree).

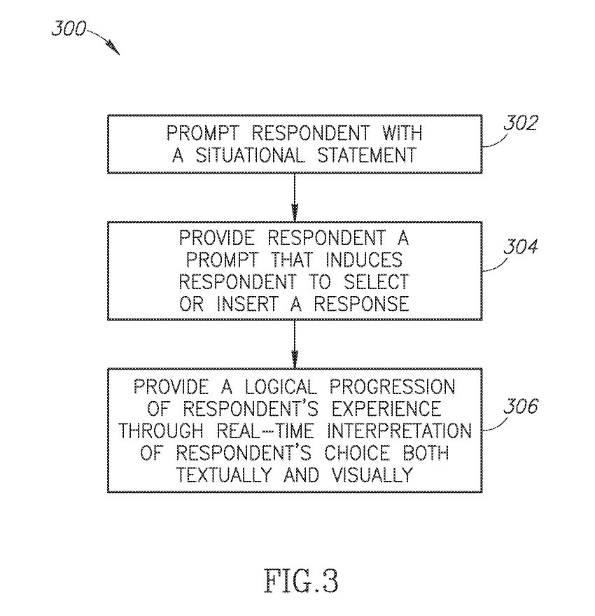

In an embodiment of the present invention, FIGS. 3-5 show an interactive method 300 that takes the form of an online questionnaire provided to one or more respondents. For purposes of brevity and clarity, the interactive method 300 discussed herein will take the form of a banking activity within a bank, but it is understood that the interactive method 300 as well as other embodiments of the present invention may be utilized in a variety of applications and throughout a variety of industries, whether public, private, indoors, outdoors or otherwise. Likewise, the online questionnaire may be designed and customized to apply to particular environments, organizations, situations or other contexts.

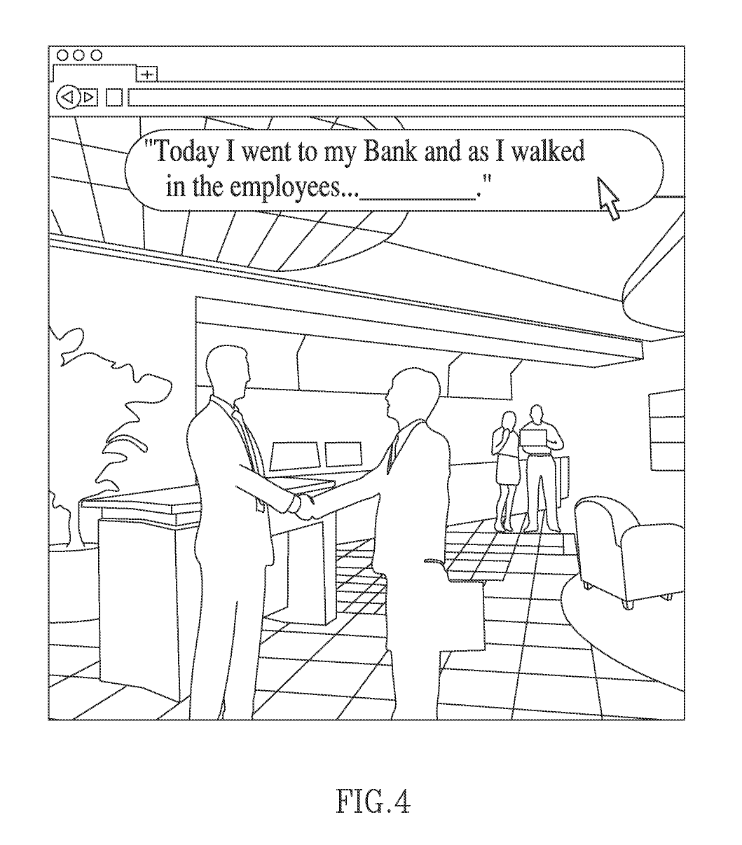

At Step 302 and as best shown in FIG. 4, the interactive method 300 may commence with a situational statement in combination with a picture or an image, which may take the form of a digital rendering or other digitally generated image, that represents an environment applicable to the questionnaire prompts. By way of example, the situational statement of “Today I went to my bank and as I walked in the employees . . . ______ ” is provided against a backdrop (e.g., picture or image) of a bank's interior layout. Stated otherwise, the online questionnaire may employ a visually contextual background and a textual situation for the respondent. The situational image or picture may take the form of an interior portion of a back in neutral colors with bank employees shown in general detail.

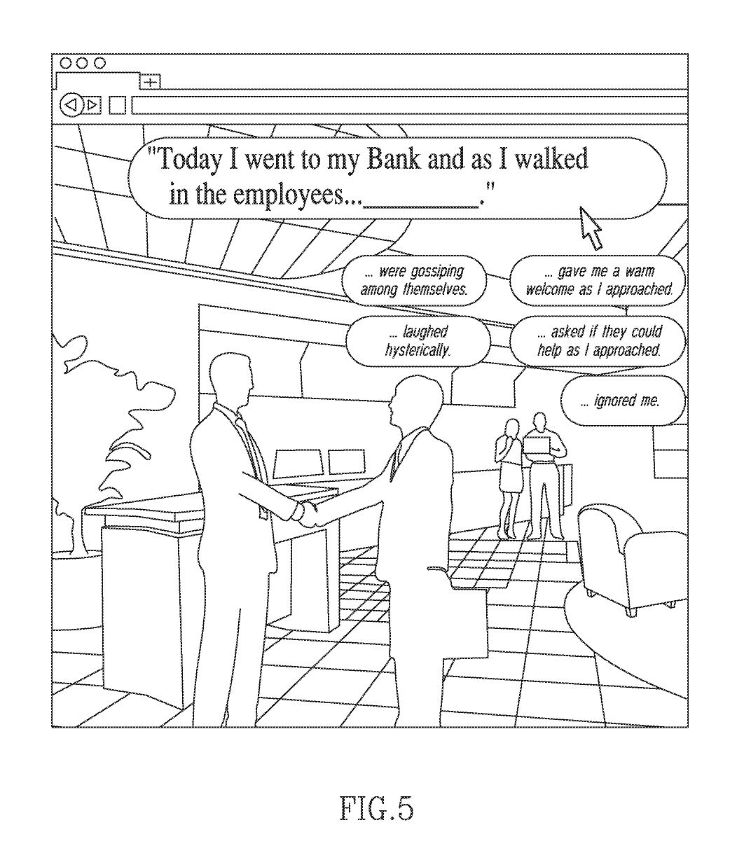

At Step 304 and as best shown in FIG. 5, the online questionnaire may begin prompting the respondent to provide feedback, and such prompts may invoke a situational context or carry an intended connotation. Referring to FIG. 5, the online questionnaire provides several textual responses options with another visually contextual background. Thus, the online questionnaire provides the response options in both a textual and a visual manner. By way of example, the available responses can range from phrases indicating a poor banking experience to phrases indicating a good banking experience. Some possible responses may include, but are not limited to, [the employees] “ . . . were gossiping among themselves;” [the employees] “ . . . ignored me;” [the employees] “ . . . asked if they could help as I approached;” [the employees] “ . . . gave me a warm welcome as I approached;” or [the employees] “ . . . laughed hysterically.”

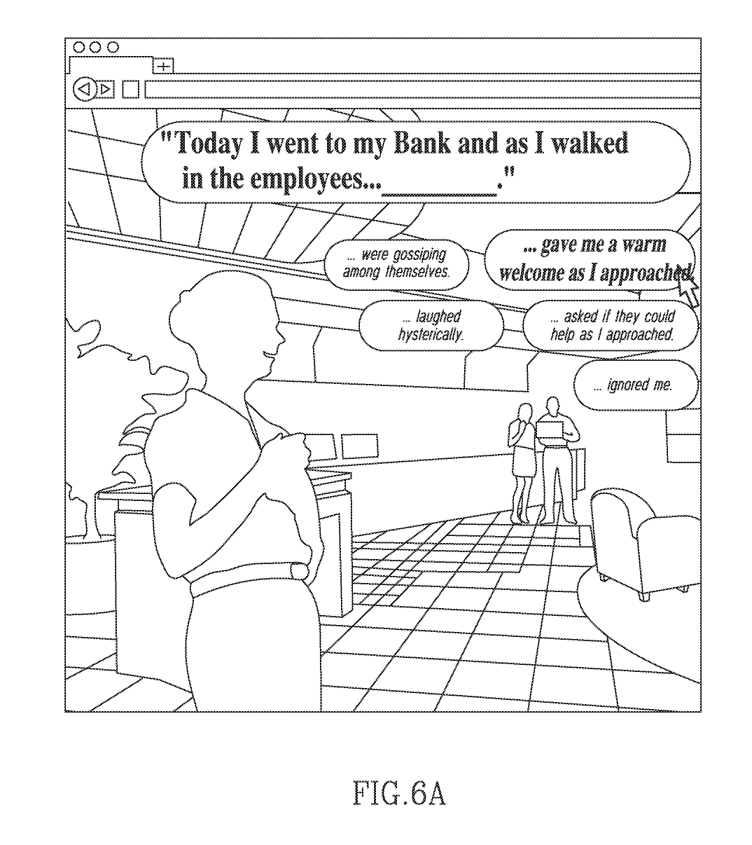

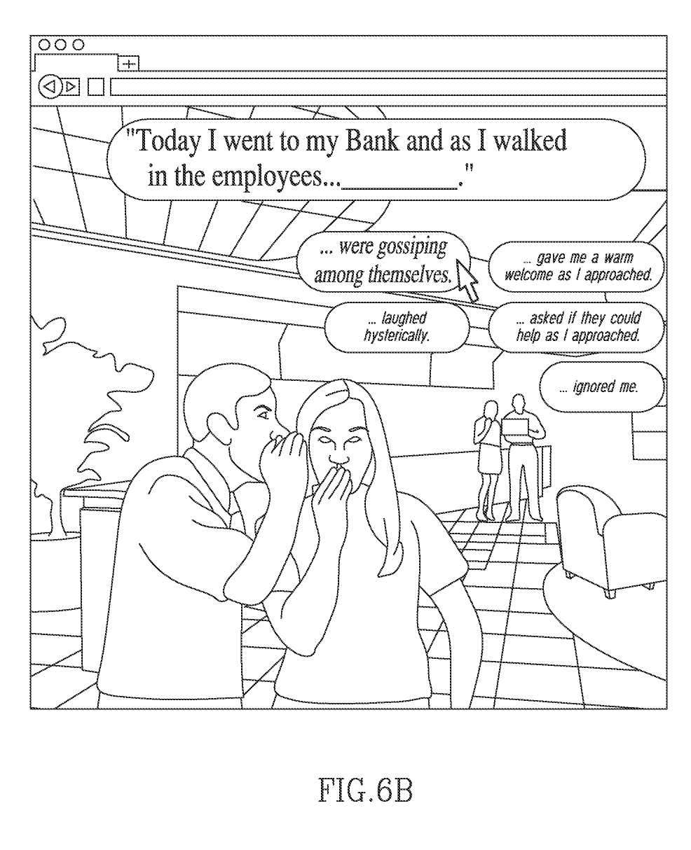

At Step 306 and referring to FIGS. 6A and 6B, the respondent is provided with various visual or textual options to reinforce the selection made by the respondent. In one embodiment, the respondent may also have an option to provide a custom response. As the respondent completes the phrase, the online questionnaire may provide, in real-time, additional phrases and/or images that correlate with a logical progression of the respondent's experience. Thus, the online questionnaire may interpret the respondent's selection or selections to allow the respondent to complete the phrase in a way that most accurately aligns with the respondent's experience. In one embodiment, the online questionnaire may present the logical progression of prompts and response options in a graphically attractive way designed to reinforce the idea that the respondent is crafting a story about their experience.

Now referring specifically to FIG. 6A, as the respondent selects an available option or drafts their own response to a given prompt, the respondent ultimately crafts a story about their experience. FIG. 6A shows the respondent answering the prompt by selecting that [the employees] “ . . . gave me a warm welcome as I approached.” The option, upon selection by the respondent, appears in a larger font and in a bold font. Thus, the online questionnaire may change the font, image, colors, layout and other aspects of the selected option to provide a deeper context for the respondent and to provide an affirmation that the respondent has selected the desired response.

In contrast, FIG. 6B shows the respondent indicating a more negative banking experience by answering the prompt with the option [the employees] “ . . . were gossiping among themselves.” Hence, the representative, enlarged text and image reinforces the respondent's answers. The interactive method 300 may then fill in additional detail showing the smiling and attentive faces of employees, etc.

In yet another example, the respondent may another option such as [the employees] “ . . . ignored me.” With this response, the interactive method 300 may provide more detail showing one or more of the bank employees appearing distracted and inattentive.

An advantage of the interactive method 300 an online questionnaire is that it allows the respondent to tell his or her story and convey their mood through an evolving chain of prompts or questions and responses associated with images that visually convey the story. As the respondent tells the story, the online questionnaire system may provide supporting illustrations along with changes in color, shading, font, brightness, etc. to better reflect logical assumptions about the respondent's mood or attitude, whether positive, negative or otherwise, about the respondent's experience.

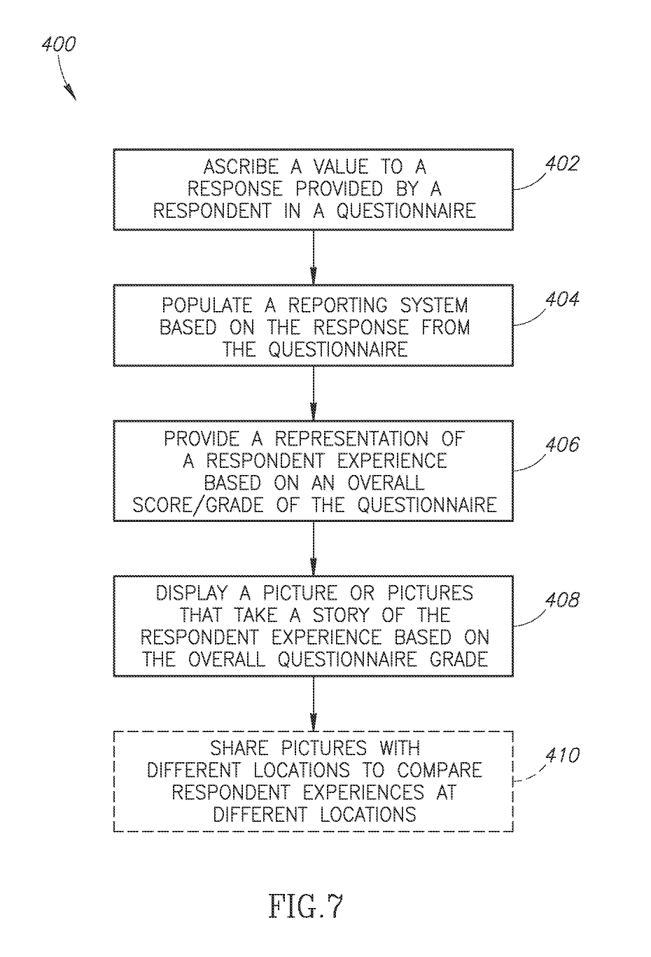

FIG. 7 shows a scoring and reporting method 400 for an online questionnaire. For data from a questionnaire to be useful as a business tool, a leadership tool, or a learning tool, an objective scoring system is preferable. In one embodiment, the method 400 produces a numerical experience satisfaction score dictated or interpreted by how a respondent tells a story by answering prompts or questions.

At Step 402, the scoring and reporting method 400 ascribes a value to a response provided by a respondent in the questionnaire. In one embodiment, the ascribed value may be a statistical value that indicates a quantifiable scoring mechanism.

At Step 404, the method 400 tabulates responses in real time to generate a report that may be integrated one or more images or pictures representative of the respondent's experience. In turn, the report may be shared, any time after its creation, among employees in different locations or shared in other ways to promote an opportunity to learn from the respondent's experience and/or revise a business practice or service. By way of example, the report may permit employees at a first location to see a statistical and visual representation of a respondent's experience at the first location as compared to another statistical and visual representation of the respondent's experience at a second location. Likewise, such a report may be shared with others from an organization for a variety of reasons and purposes.

At Step 406, the method 400 may help, for example, employees of an organization using the online questionnaire to better understand the respondent's experience by reflecting or representing an aggregated story in the report. By way of example, a first bank at the first location may receive an average statistical grade based on responses to the online questionnaire, such as an average numerical score of 2.5 points out of a possible five (5.0) points or on a five-point scale. At Step 408 and in one embodiment, a location specific report provides the average numerical score in combination with the lead prompt of “Today I went to my bank and as I walked in the employees . . . ” overlaid on an image or picture that illustrates the respondent's overall experience. The location specific report may be shared with the employees of the bank at the first location. In another embodiment, location specific reports may be further aggregated to produce an overall organization report for all locations. For example, the further aggregated report may be for an entire company that received a score of 3.8 on the five-point scale. The score may be contrasted with an image or a picture representing a general level of organizational satisfaction (or lack thereof) for the score. Optionally at Step 410, the picture may be shared with different locations to compare various experiences of respondents at different locations.

Advantageously, at least one objective of the embodiments of the present invention is to create a connection between the respondents (e.g., customers) and the employees that receive the feedback from the online questionnaire. The feedback, when provided in both a numerical and visual way, may promote increased opportunities and an increased interest for both the respondents and the feedback recipients similar to what naturally occurs between story teller and a listener when they are face-to-face or otherwise interacting. The report or reports, according to at least one embodiment, may offer empathy and promote a physiological effect that improves the employee's happiness and/or job satisfaction, which in turn may lower employee turnover and reduce new employee training costs for the organization.

The various embodiments described above can be combined to provide further embodiments. All of the above U.S. patents, patent applications and publications referred to in this specification are incorporated herein by reference. Aspects can be modified, if necessary, to employ devices, features, and concepts of the various patents, applications and publications to provide yet further embodiments.

These and other changes can be made in light of the above detailed description. In general, in the following claims, the terms used should not be construed to limit the invention to the specific embodiments disclosed in the specification and the claims, but should be construed to include all types of surveys and questionnaires, interpretations thereof, scoring, grading and dissemination of reports that utilize data either directly or indirectly from the surveys and questionnaires, as well as systems and processes that operate in accordance with the claims. Accordingly, the invention is not limited by the disclosure, but instead its scope is to be determined entirely by the following claims

1. A computer-implemented method for providing an online questionnaire to a respondent, the method comprising:
providing a situational statement to the respondent, the situational statement coupled with an image of an environment that relates to an experience of the respondent to which the questionnaire is directed;
providing a prompt to the respondent;
providing a plurality of options to the prompt;
determining a progression of subsequent prompts based on the selected option by the respondent; and
providing the subsequent prompts through a textual and a visual interface that encourages a continued interaction by the respondent.

2. The method of claim 1, wherein providing the situational statement includes providing a general statement regarding the environment related to the experience of the respondent.

3. The method of claim 1, wherein the image of the environment is a rendered image.

4. The method of claim 1, wherein providing the prompt to the respondent includes providing a question about an aspect regarding the experience of the respondent.

5. The method of claim 1, wherein providing the plurality of options includes providing textual statements selectable by the respondent.

6. The method of claim 1, wherein providing the plurality of options includes providing an input option where the respondent can generate a customized response to the prompt.

7. The method of claim 1, wherein determining the progression of subsequent prompts includes interpreting the selected option by the respondent in real-time.

8. The method of claim 1, wherein determining the progression of subsequent prompts includes generating an interactive story based on the experience of the respondent.

9. The method of claim 1, wherein providing the subsequent prompts through the textual and the visual interface includes producing an interactive storyline visible on a display screen of a computing device that relates the experience of the respondent.

10. A method for scoring and reporting results from an online questionnaire, the method comprising:
ascribing value to selected options provided by a respondent to prompts in the online questionnaire;
populating a database that includes the ascribed values;
using the ascribed values, aggregating an overall score for the online questionnaire based on an experience of the respondent; and
providing the overall score in combination with a visual depiction in a report that represents the experience of the respondent.

11. The method of claim 10, wherein aggregating the overall score includes generating a numerical score, generating a textual output, generating a graphical output, or some combination thereof.

12. The method of claim 10, further comprising aggregating the overall scores for more than one online questionnaire based on experiences of the more than one respondent, wherein aggregating the overall scores includes determining a grade.

13. The method of claim 12, further comprising providing the grade in combination with a visual depiction that represents the experiences of a population of respondents.
